(19) United States
(12) Patent Application Publication
(10) Pub. No.: US 2024/0121571 A1
(43) Pub. Date: Apr. 11, 2024

(54) PROCESSING APPARATUS, PROCESSING METHOD, AND NON-TRANSITORY STORAGE MEDIUM

(71) Applicant: NEC Corporation, Tokyo (JP)

(72) Inventors: Keisuke Ikeda, Tokyo (JP); Masahiro Tani, Tokyo (JP); Kazufumi Kojima, Tokyo (JP)

(73) Assignee: NEC Corporation, Tokyo (JP)

(21) Appl. No.: 18/528,204

(22) Filed: Dec. 4, 2023

(30) Foreign Application Priority Data
Dec. 8, 2002 (JP) 2022-196209

(51) Int. Cl. H04W 4/02; G06Q 50/00

(52) U.S. Cl. CPC H04W 4/02; G06Q 50/01

(57) ABSTRACT

To improve precision in decision in a technique for deciding an activity area of a target user, based on information of another person, the present invention provides a processing apparatus 10 including: a determination unit 11 that determines one or a plurality of reference users having a predetermined relationship with a target user whose activity area in a target period is to be estimated, based on post information posted on social media by each user within a search period being set based on the target period; an estimation unit 12 that estimates an activity area of the reference user in the target period; and a decision unit 13 that decides an activity area of the target user in the target period, based on an activity area of the reference user in the target period.

This application is based upon and claims the benefit of priority from Japanese patent application No. 2022-196209, filed on Dec. 8, 2022, the disclosure of which is incorporated herein in its entirety by reference.

### TECHNICAL FIELD

The present invention relates to a processing apparatus, a processing method, and a program.

### BACKGROUND ART

A technique relevant to the present invention is disclosed in Patent Document 1 (International Patent Publication No. WO2021/028988), Patent Document 2 (Japanese Patent Application Publication No. 2017-167793), Non-Patent Document 1 (Written by Keisuke Ikeda, Kazufumi Kojima, and Masahiro Tani, “Study for estimating the residential area focused on geographical proximity of friends”, The Institute of Electronics, Information and Communication Engineers, IEICE technical report, Vol. 119, No. 317, pp. 37-42, AI2019-36, November 2019), Non-Patent Document 2 (Written by Dan Xu, Peng Cui, Wenwu Zhu, and Shiqiang Yang, “Graph-based residence location inference for social media users”, IEEE Computer Society, IEEE MultiMedia, Volume 21, Issue 4, pp. 76-83, October 2014), Non-Patent Document 3 (Written by Backstrom Lars, Eric Sun, and Cameron Marlow, “Find me if you can: Improving geographical prediction with social and spatial proximity” Proceedings of the 19^{th} international conference on World Wide Web, 2010, pp.61-70), Non-Patent Document 4 (Written by Liu Zhi and Yan Huang, “Closeness and structure of friends help to estimate user locations”, International Conference on Database Systems for Advanced Applications, Springer, pp. 33-48), and Non-Patent Document 5 (Written by Keisuke Ikeda, Kazufumi Kojima, and Masahiro Tani, “Social media user's location estimation method based on Kernel Density Estimation”, The Institute of Electronics, Information and Communication Engineers, IEICE technical report, Vol. 120, No. 379, pp. 18-23, AI2020-42, February 2021).

Patent Document 1 and Non-Patent Documents 1 to 5 disclose a technique for deciding an activity area of a user who has an account with social media such as a social networking service (SNS) and the like. In addition, Patent Document 1 discloses a technique for computing a degree of friendship in real space between a target user and another user who has a relation with the target user on social media, giving a weight to the another user, based on the degree, and deciding an activity area of the target user, based on the weight.

Patent Document 2 discloses a technique for computing a degree of intimacy between persons captured in an image.

### DISCLOSURE OF THE INVENTION

There is a technique for deciding an activity area of a target user, based on post information of the target user.

However, in a case of the technique, an activity area of a target user cannot be decided for a period in which the target user has not posted enough post information.

As in the technique disclosed in Patent Document 1, an activity area of a target user is decided based on information of a friend of the target user, more specifically, a friend who has a connection not only on social media but also in real space, and thereby it is possible to decide the activity area of the target user even for a period in which the target user has not posted enough post information.

However, even a friend who has a connection in real space does not always act together with a target user. Normally, frequency of acting together with each friend may vary for each time. For example, in a case of a friend from school or a friend from hometown, a target user may have often acted together with the friend in a past, but may live far away from the friend now and see the friend only occasionally (example: several times a year). Further, in a case of a newfound friend, a target user often acts together with the friend now, but of course has not acted together at all in the past. In a case of the technique disclosed in Patent Document 1 in which such a situation is not considered, precision in deciding an activity area of a target user deteriorates. None of the other documents discloses the above problem and a solution thereof.

In view of the above-described problem, one example of an object of the present invention is to provide a processing apparatus, a processing method, and a program that solve a problem of improving precision in decision in a technique for deciding an activity area of a target user, based on information of another person.

According to one aspect of the present invention, provided is a processing apparatus including:
a determination unit that determines one or a plurality of reference users having a predetermined relationship with a target user whose activity area in a target period is to be estimated, based on post information posted on social media by each user within a search period being set based on the target period;
an estimation unit that estimates an activity area of the reference user in the target period; and
a decision unit that decides an activity area of the target user in the target period, based on an activity area of the reference user in the target period.

According to one aspect of the present invention, provided is a processing method including,
by one or more computers;
determining one or a plurality of reference users having a predetermined relationship with a target user whose activity area in a target period is to be estimated, based on post information posted on social media by each user within a search period being set based on the target period;
estimating an activity area of the reference user in the target period; and
deciding an activity area of the target user in the target period, based on an activity area of the reference user in the target period.

According to one aspect of the present invention, provided is a program causing a computer to function as:
a determination unit that determines one or a plurality of reference users having a predetermined relationship with a target user whose activity area in a target period is to be estimated, based on post information posted on social media by each user within a search period being set based on the target period;
an estimation unit that estimates an activity area of the reference user in the target period; and
a decision unit that decides an activity area of the target user in the target period, based on an activity area of the reference user in the target period.

According to one aspect of the present invention, a processing apparatus, a processing method, and a program that solve a problem of improving precision in decision in a technique for deciding an activity area of a target user, based on information of another person, are achieved.

### BRIEF DESCRIPTION OF THE DRAWINGS

The above-described object and other objects, features, and advantageous effects become more apparent from the preferred example embodiments described below and the following accompanying drawings.

FIG. 1 is a diagram illustrating one example of a function block diagram of a processing apparatus.

FIG. 2 is a diagram for describing an overview of the processing apparatus.

FIG. 3 is a diagram illustrating one example of a hardware configuration of the processing apparatus.

FIG. 4 is a diagram for describing one example of input/output of a determination unit.

FIG. 5 is a diagram for describing one example of input/output of an estimation unit.

FIG. 6 is a diagram for describing one example of input/output of a decision unit.

FIG. 7 is a diagram for describing one example of processing of the decision unit.

FIG. 8 is a flowchart illustrating one example of a flow of processing of the processing apparatus.

FIG. 9 is a flowchart illustrating another example of a flow of processing of the processing apparatus.

FIG. 10 is a diagram illustrating one example of a function block diagram of the estimation unit.

### DESCRIPTION OF EMBODIMENTS

Hereinafter, example embodiments of the present invention will be described by using drawings. Note that, in every drawing, a similar component is given a similar sign, and description thereof is omitted as appropriate.

### First Example Embodiment

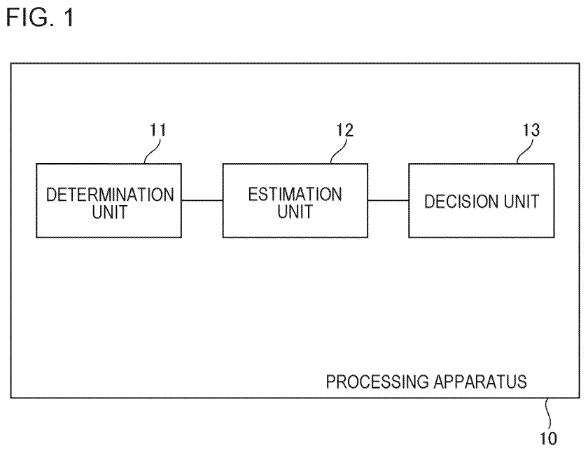

FIG. 1 is a function block diagram illustrating an overview of a processing apparatus 10 according to a first example embodiment. The processing apparatus 10 includes a determination unit 11, an estimation unit 12, and a decision unit 13.

The determination unit 11 determines one or a plurality of reference users having a predetermined relationship with a target user whose activity area in a target period is to be estimated, based on post information posted on social media by each user within a search period being set based on the target period. The estimation unit 12 estimates an activity area of the reference user in the target period. The decision unit 13 decides an activity area of the target user in the target period, based on an activity area of the reference user in the target period.

The processing apparatus 10 including such a configuration solves a problem of improving precision in decision in a technique for deciding an activity area of a target user, based on information of another person.

### Second Example Embodiment

### Overview

A processing apparatus 10 according to a second example embodiment is a more specific embodiment of the processing apparatus 10 according to the first example embodiment.

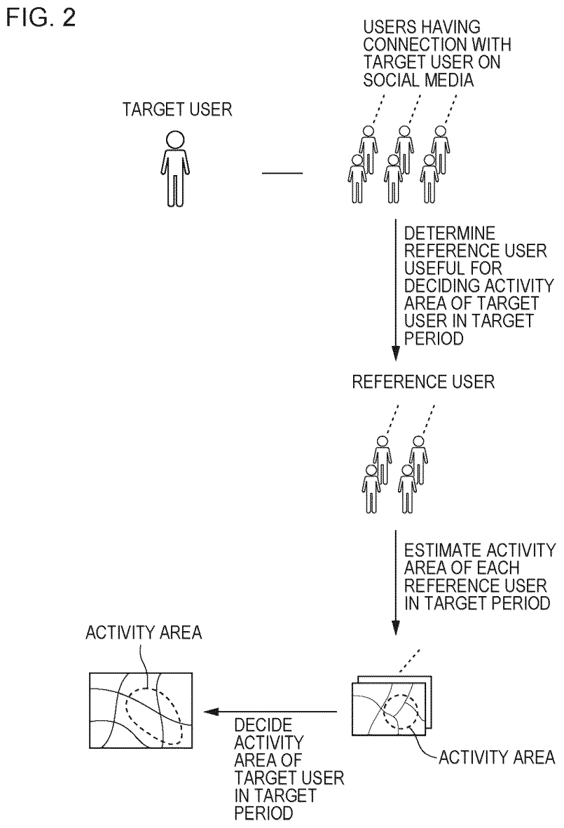

A concept of the processing apparatus 10 according to the present example embodiment will be described by using FIG. 2. The processing apparatus 10 decides an activity area of a target user in a “target period”, based on information of another person such as a friend of the target user. That is, in the present example embodiment, a period for which an activity area of a target user is decided is determined.

As illustrated in FIG. 2, the processing apparatus 10 determines, from among a plurality of users having a connection with a target user on social media, a reference user who is useful for deciding an activity area of the target user in a target period. For example, a user who has posted an image including the target user within a search period being set based on the target period, a user who has posted a message mentioning the target user within the search period, a user who has posted post information in which the target user is tagged within the search period, or the like is determined as a reference user.

Then, the processing apparatus 10 estimates an activity area of each of the reference users in the target period, and then decides an activity area of the target user in the target period, based on an estimation result thereof.

As described above, the processing apparatus 10 according to the present example embodiment that determines, from among a plurality of users having a connection with a target user on social media, a reference user who is useful for deciding an activity area of the target user in a target period, and decides an activity area of the target user in the target period, based on an activity area of the determined reference user, can precisely decide an activity area of the target user in the target period. Hereinafter, a configuration of the processing apparatus 10 will be described in more detail.

### Hardware Configuration

Next, one example of a hardware configuration of the processing apparatus 10 will be described. Each function unit of the processing apparatus 10 is achieved by any combination of hardware and software, mainly including a central processing unit (CPU) of any computer, a memory, a program to be loaded in a memory, a storage unit (in which a program downloaded from a storage medium such as a compact disc (CD), a server on the Internet, or the like can be stored, in addition to a program stored in advance in a stage of shipping an apparatus) such as a hard disk for storing the program, and an interface for network connection. In addition, it should be understood by a person skilled in the art that there are a variety of modified examples of a method or an apparatus for achieving the same.

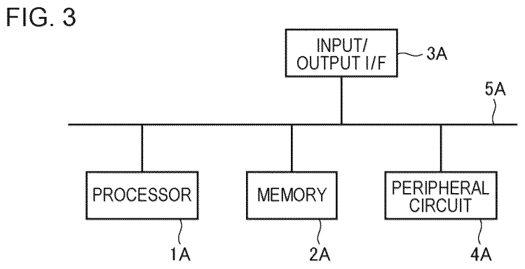

FIG. 3 is a block diagram illustrating a hardware configuration of the processing apparatus 10. As illustrated in FIG. 3, the processing apparatus 10 includes a processor 1A, a memory 2A, an input/output interface 3A, a peripheral circuit 4A, and a bus 5A. The peripheral circuit 4A includes various modules. The processing apparatus 10 may not include the peripheral circuit 4A. Note that, the processing apparatus 10 may be configured by a plurality of physically and/or logically separated apparatuses. In this case, each of the plurality of apparatuses can include the above hardware configuration.

The bus 5A is a data transmission path through which the processor 1A, the memory 2A, the peripheral circuit 4A, and the input/output interface 3A transmit and receive data to and from one another. The processor 1A is an arithmetic processing apparatus such as, for example, a CPU or a graphics processing unit (GPU). The memory 2A is a memory such as, for example, a random access memory (RAM) or a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can give an instruction to each module to perform an arithmetic operation, based on an arithmetic operation result thereof.

### Function Configuration

Next, a function configuration of the processing apparatus 10 according to the second example embodiment will be described in detail. FIG. 1 illustrates one example of a function block diagram of the processing apparatus 10. As illustrated, the processing apparatus 10 includes a determination unit 11, an estimation unit 12, and a decision unit 13.

The determination unit 11 determines one or a plurality of reference users having a predetermined relationship with a target user, based on post information posted on social media by each user within a search period.

Specifically, first, the determination unit 11 determines a user having a connection with a target user on social media. Then, the determination unit 11 determines a reference user from among the determined users, based on post information (that is, by analyzing post information) of the determined user within a search period.

A “target user” is a user whose activity area is to be estimated. In the present example embodiment, an activity area of the target user in a target period is decided. Any user among users having an account on social media can be specified as the target user.

A “target period” is a period for which an activity area of a target user is decided. An operator of the processing apparatus 10 may specify the target period. Besides the above, the processing apparatus 10 may automatically specify the target period with any algorithm.

An “activity area” is an area where each user acts in actual world (real space). For example, the activity area may be indicated in a unit of municipalities or the like, may be indicated by an area wider than the unit, or may be indicated by an area narrower than the unit.

A “user having a connection with a target user” is a user who has some connection with a target user on social media among users having an account on the social media. For example, at least one of a user in a relationship of following each other with the target user, a user followed by the target user, a user following the target user, a user having a history of message exchange with the target user, and a user who has been in a same place at same timing as a user of each account is a user having a connection with the target user.

“Having a history of message exchange” may be a state in which at least one user has sent text data, an emoji, a picture, a video, a voice, an icon, or the like to another user, or has performed an action by depressing a like button. Besides the above, “having a history of message exchange” may be a state in which both users have sent text data, an emoji, a picture, a video, a voice, an icon, or the like to each other, or have performed an action by depressing a like button to each other.

A “user who has been in a same place at same timing as a target user” may be determined based on, for example, a post location and a post date and time. When a difference in post date and time between posts of a target user and another user is within a reference value, and post locations are same or a difference thereof is within a reference value, the two users may be decided as having been in a same place at same timing. Besides the above, when a global positioning system (GPS) tracks a position of a user of each account, two users whose mutual distance has been within a threshold value or two users whose state of mutual distance being within a threshold value has continued for predetermined time or more may be decided as having been in a same place at same timing. Besides the above, when a facility (a store or the like) used by each user and a date and time of use can be acquired, two users who have used a same facility and whose difference in use date and time is within a reference value may be decided as having been in a same place at same timing. A facility (a store or the like) used by each user and a date and time of use may be determined based on a post of each user, or may be determined with other approaches.

The processing apparatus 10 acquires, from a server providing a service of social media, public information being published on the server. The public information includes post information of each user, a profile of each user, information indicating a connection with another user on the above social media, and the like. Then, the determination unit 11 determines a user having a connection with a target user, based on the public information.

“Post information” is information posted on social media and being published (that is, not in a state of being unable to be viewed due to a viewing restriction or the like). The post information includes a message, a still image, a moving image, a voice, and additional information (a tag or the like) attached thereto.

A “profile” is information introducing each user. The profile may include items such as, which may vary from social media to social media, for example, a user name, a nickname, gender, a date of birth, nationality, age (or an age group), a birthplace, a current place of residence, affiliation (a company name, a school name), and a school from which one has graduated.

A “reference user” is a user who is useful for deciding an activity area of a target user in a target period among users having an account on social media. A user having a predetermined relationship with the target user is determined as a reference user. In the present example embodiment, the reference user is determined from among users having a connection with the target user.

A “predetermined relationship” includes at least one of
having posted an image including a target user within a search period,
having posted a message mentioning the target user within a search period,
having posted post information in which the target user is tagged within a search period, and
having been in a same place at same timing as the target user within a search period.

A “search period” is a period being set based on a target period. For example, the target period per se may be set as a search period. For example, when a target period is “Jul. 7 to Jul. 15, 2022”, “Jul. 7 to Jul. 15, 2022” may be set as the search period. Besides the above, a period acquired by extending the target period with any approach may be set as the search period. For example, when the target period is “Jul. 7 to Jul. 15, 2022”, “Jul. 6 to Jul. 16, 2022”, which is acquired by extending the target period by one day each before and after, may be set as the search period. Besides the above, a period acquired by shortening the target period with any approach may be set as the search period. For example, when the target period is “Jul. 7 to Jul. 15, 2022”, “Jul. 8 to Jul. 14, 2022”, which is acquired by shortening the target period by one day each from beginning and end, may be set as the search period.

Processing of determining a reference user having a predetermined relationship as described above with a target user can be achieved by using any possible technique.

For example, the determination unit 11 extracts, from the above-described public information, a post image posted within a search period by a user having a connection with a target user on social media. Then, the determination unit 11 detects the target user from the extracted post image, and thereby determines “a user who has posted an image including the target user within the search period”. Processing of detecting a target user from a post image may be achieved by, for example, collation processing using an appearance feature value (for example, a facial feature value) of the target user. In this case, the appearance feature value of the target user or an image of the target user is registered in advance in the processing apparatus 10.

Besides the above, the determination unit 11 extracts, from the above-described public information, a message posted within a search period by a user having a connection with a target user on social media. Then, the determination unit 11 detects a name or a nickname of the target user from the extracted message, and thereby determines “a user who has posted a message mentioning the target user within the search period”. In this case, the name or the nickname of the target user is registered in advance in the processing apparatus 10.

Besides the above, the determination unit 11 extracts, from the above-described public information, post information posted within a search period by a user having a connection with a target user on social media. Then, the determination unit 11 detects post information in which the target user is tagged from among pieces of the extracted post information, and thereby determines “a user who has posted post information in which the target user is tagged within the search period”.

Further, the determination unit 11 can determine “a user who has been in a same place at same timing as a target user within a search period” by using the above-described approach for determining “a user who has been in a same place at same timing as the target user”.

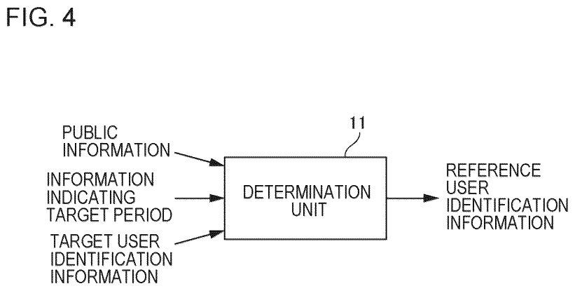

As illustrated in FIG. 4, the determination unit 11 receives inputs of “public information” being published on social media, “information indicating a target period” being a period for which an activity area of a target user is decided, and “identification information of the target user”.

The determination unit 11 executes, based on these pieces of information, “processing of determining a user having a connection with the target user on social media” and “processing of further determining a reference user having a predetermined relationship with the target user from among the determined users, based on post information of the determined user within a search period”.

Then, the determination unit 11 outputs “identification information of the determined reference user”.

Returning to FIG. 1, the estimation unit 12 estimates an activity area of a reference user in a target period. When a plurality of reference users are determined by the determination unit 11, the estimation unit 12 estimates an activity area of each reference user in the target period.

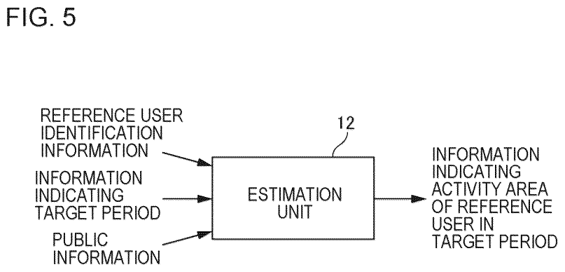

As illustrated in FIG. 5, the estimation unit 12 receives inputs of “public information” being published on social media, “information indicating a target period”, and “identification information of a reference user”. The estimation unit 12 estimates an activity area of each reference user in the target period, based on the input information. Then, the estimation unit 12 outputs “information indicating the activity area of each reference user in the target period”.

The estimation unit 12 estimates an activity area of a reference user in a target period, based on public information of the reference user. For example, the estimation unit 12 estimates an activity area of the reference user in the target period, based on at least a part of a profile of the reference user, post information posted by the reference user within the target period, public information of a user having a connection with the reference user on social media, and the like. A detailed algorithm for the estimation processing is not particularly limited, and any technique can be employed. For example, the estimation unit 12 may estimate an activity area of the reference user in the target period by using the technique disclosed in Patent Document 1, Non-Patent Documents 1 to 5, and the like. In the following example embodiment, one example of processing performed by the estimation unit 12 will be described.

The decision unit 13 decides an activity area of a target user in a target period, based on an activity area of a reference user in the target period.

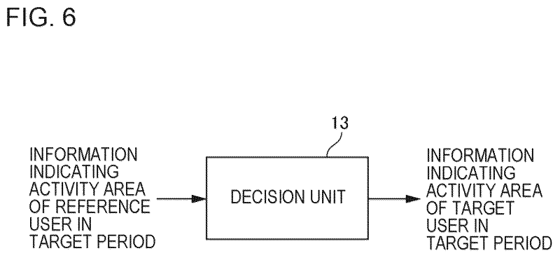

As illustrated in FIG. 6, the decision unit 13 receives an input of “information indicating an activity area of a reference user in a target period”. The decision unit 13 decides an activity area of a target user in the target period, based on the input information. Then, the decision unit 13 outputs “information indicating the activity area of the target user in the target period”.

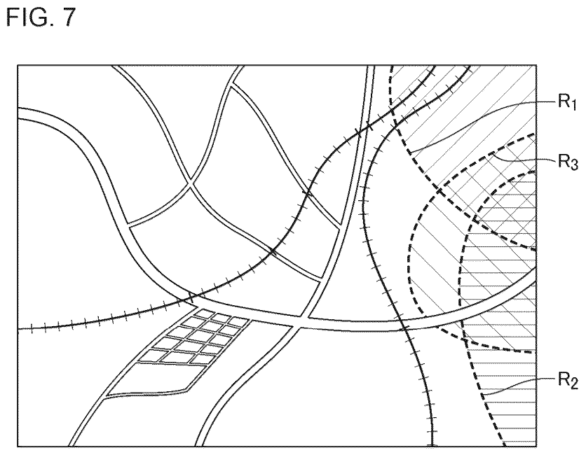

Herein, one example of decision processing performed by the decision unit 13 will be described. An activity area of each of a plurality of reference users in a target period is illustrated, for example, as in FIG. 7. An area R₁ is an activity area of a first reference user in the target period, an area R₂ is an activity area of a second reference user in the target period, and an area R₃ is an activity area of a third reference user in the target period.

The decision unit 13 may decide, for example, an area being an activity area of at least one reference user in the target period, to be an activity area of the target user in the target period. In a case of the example in FIG. 7, an area occupied by any of the areas R₁, R₂, and R₃ is decided to be an activity area of the target user in the target period.

Besides the above, the decision unit 13 may decide, for example, an area being an activity area of a predetermined number or more of reference users in the target period, to be an activity area of the target user in the target period. In the example in FIG. 7, when the predetermined number is two, an area where the area R₁ and the area R₂ overlap each other, an area where the area R₁ and the area R₃ overlap each other, an area where the area R₂ and the area R₃ overlap each other, and an area where the area R₁, the area R₂, and the area R₃ overlap one another are decided to be an activity area of the target user in the target period.

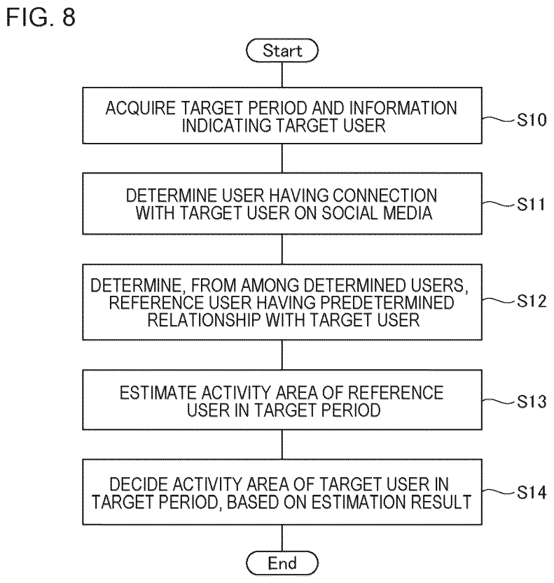

Next, one example of a flow of processing of the processing apparatus 10 will be described by using a flowchart in FIG. 8.

When acquiring a target period and information indicating a target user (identification information of a target user) (S10), the processing apparatus 10 determines a user having a connection with the target user on social media, based on public information being published on social media (S11).

Then, the processing apparatus 10 determines, from among the users determined in S11, a reference user having a predetermined relationship with the target user (S12). The predetermined relationship includes at least one of “having posted an image including the target user within a search period”, “having posted a message mentioning the target user within the search period”, “having posted post information in which the target user is tagged within the search period”, and “having been in a same place at same timing as the target user within the search period”. The processing apparatus 10 determines the reference user, based on public information being published on social media.

Then, the processing apparatus 10 estimates an activity area of each of the reference users in the target period determined in S12 (S13). The processing apparatus 10 estimates an activity area of each of the reference users in the target period, based on public information being published on social media.

Then, the processing apparatus 10 decides an activity area of the target user in the target period, based on the activity area of each of the reference users in the target period estimated in S13 (S14).

### Advantageous Effect

The processing apparatus 10 according to the present example embodiment determines, from among a plurality of users having a connection with a target user on social media, a reference user who is useful for deciding an activity area of the target user in a target period, and decides an activity area of the target user in the target period, based on an activity area of the determined reference user. The processing apparatus 10 as described above can precisely decide an activity area of the target user in the target period.

Further, the processing apparatus 10 according to the present example embodiment can determine a user having a connection with a target user on social media, and can determine a reference user from among the determined users. As described above, the processing apparatus 10 that determines the reference user after narrowing down users having a connection with the target user on social media can reduce a computer load.

Further, the processing apparatus 10 according to the present example embodiment can determine, as a reference user, at least one of a user who has posted an image including a target user within a search period, a user who has posted a message mentioning the target user within the search period, a user who has posted post information in which the target user is tagged within the search period, and a user who has been in a same place at same timing as the target user within the search period. The processing apparatus 10 as described above can precisely determine a reference user who is useful for deciding an activity area of a target user in a target period.

### Third Example Embodiment

A processing apparatus 10 according to a present example embodiment sets a weight for a determined reference user. A larger weight is set for a reference user who is considered to be more useful for deciding an activity area of a target user in a target period. Then, the processing apparatus 10 decides an activity area of the target user in the target period in consideration of the weight. Hereinafter, description will be given in detail.

A decision unit 13 sets a weight for each of a plurality of reference users determined by an estimation unit 12, based on post information of each of the plurality of reference users within a search period. As described above, a larger weight is set for a reference user who is considered to be more useful for deciding an activity area of a target user in a target period.

For example, the decision unit 13 may set a weight, based on at least one of
the number of “images including a target user” posted within a search period,
the number of “messages mentioning the target user” posted within the search period, and
the number of “pieces of post information in which the target user is tagged” posted within the search period.

In this case, the decision unit 13 sets a larger weight when the number of “images including a target user” posted within a search period is larger, when the number of “messages mentioning the target user” posted within the search period is larger, or when the number of “pieces of post information in which the target user is tagged” posted within the search period is larger.

As another example, the decision unit 13 may set a weight, based on at least one of
the number of days having posted “an image including a target user” within a search period,
the number of days having posted “a message mentioning the target user” within the search period, and
the number of days having posted “post information in which the target user is tagged” within the search period.

In this case, the decision unit 13 sets a larger weight when the number of days having posted “an image including a target user” within a search period is larger, when the number of days having posted “a message mentioning the target user” within the search period is larger, or when the number of days having posted “post information in which the target user is tagged” within the search period is larger.

Then, the decision unit 13 decides an activity area of the target user in the target period, based on an activity area of each of the plurality of reference users in the target period and the weight of each of the plurality of reference users. The decision unit 13 decides an activity area of the target user in the target period, by focusing more on an activity area of a reference user having a relatively larger weight.

Herein, one example of processing of deciding an activity area of a target user in a target period in consideration of a weight will be described by using FIG. 7.

In FIG. 7, an activity area of each of a first to third reference users in a target period is illustrated. An area R₁ is an activity area of the first reference user in the target period, an area R₂ is an activity area of the second reference user in the target period, and an area R₃ is an activity area of the third reference user in the target period.

The decision unit 13 gives, to an activity area of each reference user, a score according to a weight of each reference user. The decision unit 13 gives, to an area where activity areas of a plurality of reference users overlap, a score according to a weight of each of the plurality of reference users. For example, the decision unit 13 may give, to an area where activity areas of a plurality of reference users overlap, a score acquired by adding up scores according to weights of the plurality of reference users.

Herein, a specific example of processing using a weight will be described. Note that, the specific example to be described herein is merely one example, and is not limited thereto.

First, it is assumed that a weight of “1.0” is set for the first reference user, a weight of “0.3” is set for the second reference user, and a weight of “0.7” is set for the third reference user. In addition, it is assumed that the weight of each reference user is given as a score to an activity area of each reference user.

In this case, a score of “1.0” is given to the area R₁ being an activity area of the first reference user, a score of “0.3” is given to the area R₂ being an activity area of the second reference user, and a score of “0.7” is given to the area R₃ being an activity area of the third reference user. Then, a score of “1.3” is given to an area where the area R₁ and the area R₂ overlap each other, a score of “1.7” is given to an area where the area R₁ and the area R₃ overlap each other, a score of “1.0” is given to an area where the area R₂ and the area R₃ overlap each other, and a score of “2.0” is given to an area where the area R₁, the area R₂, and the area R₃ overlap one another.

The decision unit 13 gives a score for each area in this way, and thereafter decides an area having a score of a threshold value or more to be an activity area of a target user in a target period.

Other configurations of the processing apparatus 10 according to the present example embodiment are similar to the configurations of the processing apparatus 10 according to the first and second example embodiments.

The processing apparatus 10 according to the present example embodiment achieves an advantageous effect similar to the processing apparatus 10 according to the first and second example embodiments.

Further, among a plurality of reference users who have posted an image including a target user, have posted a message mentioning the target user, or have posted post information in which the target user is tagged within a search period, there are users having various degrees of connection with the target user. For such a plurality of reference users, the processing apparatus 10 can set a weight for the reference user according to a degree of usefulness for deciding an activity area of the target user in a target period, and can decide an activity area of the target user in the target period in consideration of the weight. Consequently, the processing apparatus 10 can precisely decide an activity area of a target user in a target period.

### Fourth Example Embodiment

A processing apparatus 10 according to a present example embodiment decides an activity area of a target user in a target period with the processing described in the first to third example embodiments when the number of pieces of post information posted on social media by the target user within the target period is less than a reference value, that is, the number is insufficient for estimating an activity area of the target user. Hereinafter, description will be given in detail.

A decision unit 13 has a first mode and a second mode for processing of deciding an activity area of a target user in a target period. That is, the decision unit 13 can decide an activity area of a target user in a target period by using the first mode or the second mode.

In the first mode, the decision unit 13 decides an activity area of a target user in a target period, based on post information posted by the target user. For example, the decision unit 13 can decide an activity area of the target user in the target period by using the technique disclosed in Patent Document 1, Non-Patent Documents 1 to 5, and the like.

In the second mode, the decision unit 13 decides an activity area of a target user in a target period, based on an activity area of a reference user in the target period. That is, the processing described in the first to third example embodiments is the second mode.

The decision unit 13 executes the first mode when the number of pieces of post information posted on social media by a target user within a target period is equal to or more than a reference value. In addition, the decision unit 13 executes the second mode when the number of pieces of post information posted on social media by the target user within the target period is less than the reference value.

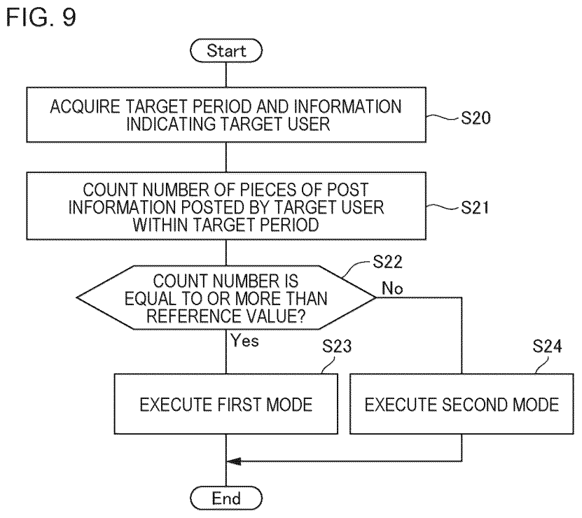

Herein, one example of a flow of processing of the processing apparatus 10 will be described by using a flowchart in FIG. 9.

When acquiring a target period and information indicating a target user (identification information of a target user) (S20), the processing apparatus 10 counts the number of pieces of post information posted by the target user within the target period, based on public information being published on social media (S21).

When the count number is equal to or more than a reference value (Yes in S22), the processing apparatus 10 decides an activity area of the target user in the target period by using the first mode (S23). That is, the processing apparatus 10 decides an activity area of the target user in the target period, based on post information posted by the target user.

On the other hand, when the count number is less than the reference value (No in S22), the processing apparatus 10 decides an activity area of the target user in the target period by using the second mode (S24). That is, the processing apparatus 10 decides an activity area of the target user in the target period, based on an activity area of a reference user in the target period. More specifically, the processing apparatus 10 executes the above-described processing from S11 to S14 in FIG. 8.

Other configurations of the processing apparatus 10 according to the present example embodiment are similar to the configurations of the processing apparatus 10 according to the first to third example embodiments.

The processing apparatus 10 according to the present example embodiment achieves an advantageous effect similar to the processing apparatus 10 according to the first to third example embodiments. Further, the processing apparatus 10 can decide an activity area of a target user in a target period by using an appropriate mode according to the number of pieces of post information posted on social media by the target user within the target period. The processing apparatus 10 can precisely decide an activity area of a target user in a target period by executing an appropriate mode according to a situation.

### Fifth Example Embodiment

A processing apparatus 10 according to a present example embodiment uses a specifically embodied method of estimating an activity area of a reference user by an estimation unit 12. Hereinafter, description will be given in detail.

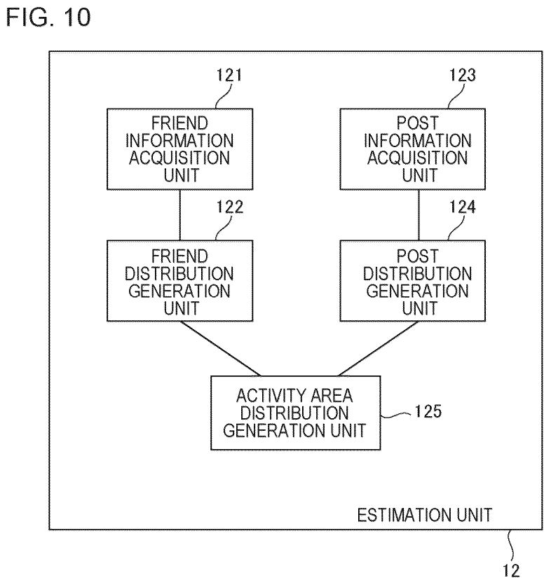

As illustrated in FIG. 10, the estimation unit 12 includes a friend information acquisition unit 121, a friend distribution generation unit 122, a post information acquisition unit 123, a post distribution generation unit 124, and an activity area distribution generation unit 125.

The friend information acquisition unit 121 acquires a profile from public information of a friend (a user having a connection on social media) of a reference user. A “user having a connection on social media”, “public information”, and a “profile” are as described above.

The friend distribution generation unit 122 generates a residential place distribution indicating a distribution of places of residence of the reference user, based on the profile of the friend of the reference user acquired by the friend information acquisition unit 121. While there are various methods of generating a residential place distribution, for example, a first term on a right-hand side of a following expression (1) is one example of an expression for generating a residential place distribution. Incidentally, a second term on the right-hand side of the following expression (1) is one example of an expression for generating a post distribution.

The post information acquisition unit 123 acquires, from public information of the reference user, post information indicating a post location and a post date and time.

The post distribution generation unit 124 generates, based on the information acquired by the post information acquisition unit 123, a post location distribution indicating a distribution of post locations of the reference user in a target period.

The activity area distribution generation unit 125 estimates an activity area of the reference user, based on the residential place distribution and the post location distribution. Hereinafter, processing examples will be described.

### First Processing Example

For example, the activity area distribution generation unit 125 may determine an area acquired by multiplying a residential place distribution by a post location distribution to be an activity area of a reference user. An arithmetic operation for the approach is indicated by the following expression (1).

$$[ Mathematical 1 ]$$

$$p ( L ) ∝ \{ \frac{1}{\vert f \vert {h}_{f}} {\sum }_{1}^{f} {w}_{f} {K}_{f} ( {l}_{f} ) \} \{ \frac{1}{\vert p \vert {h}_{p}} {\sum }_{1}^{p} {w}_{p} {K}_{p} ( {l}_{p} ) \} \qquad Expression ( 1 )$$

The first term on the right-hand side represents a residential place distribution, and the second term represents a post location distribution. A distribution of activity areas of a reference user is estimated based on these distributions. f is an abbreviation for friend. A variable with a subscript f is a variable relating to a friend. p is an abbreviation for post. A variable with a subscript p is a variable relating to a post. l_{f} is a set of places of residence of a friend of a reference user, h_{f} is a bandwidth for a friend, w_{f} is a weight for a friend, and K_{f} is a kernel function for a friend. lₚ is a set of post locations of a reference user, hₚ is a bandwidth for a post, wₚ is a weight for a post, and Kₚ is a kernel function for a post. L is a set of l_{f} and lₚ.

A bandwidth is a parameter indicating a range of influence of each sample in kernel density estimation.

A bandwidth for a post is a predetermined value for a post distribution, and may be set in advance, or may be a value acquired by learning in advance from a plurality of post locations. The bandwidth for a post may be changed according to an output activity area (an estimation result).

A bandwidth for a friend is a predetermined value for a friend distribution, and may be set in advance similarly to a bandwidth for a post, or may be a value acquired by learning from places of residence of a plurality of friends. The bandwidth for a friend may be different from or same as a bandwidth for a post. The bandwidth for a friend may be changed according to an output activity area (an estimation result).

### Second Processing Example

Besides the above, the activity area distribution generation unit 125 may estimate an area where there is most overlap between a residential place distribution and a post location distribution as an activity area of a reference user.

### Third Processing Example

Besides the above, the activity area distribution generation unit 125 may estimate an area with a radius of r km from the activity area assumed in the second processing example, as an activity area of a reference user.

Other configurations of the processing apparatus 10 according to the present example embodiment are similar to the configurations of the processing apparatus 10 according to the first to fourth example embodiments.

The processing apparatus 10 according to the present example embodiment achieves an advantageous effect similar to the processing apparatus 10 according to the first to fourth example embodiments. Further, the processing apparatus 10 according to the present example embodiment can precisely estimate an activity area of a reference user.

### Modified Example

Herein, modified examples applicable to the first to fifth example embodiments will be described. An advantageous effect similar to the first to fifth example embodiments is achieved also in the modified examples.

### First Modified Example

In the first to fifth example embodiments, the determination unit 11 determines a reference user having a predetermined relationship with a target user from among a plurality of users having a connection with the target user on social media. In a first modified example, a reference user having a predetermined relationship with a target user may be determined from among all users on social media.

In such a case, in addition to a reference user that can be determined in the first to fifth example embodiments, a user who has no connection with a target user either on social media or in real space but has just happened to be in a same place at same timing, and has posted an image in which the target user happens to be captured can be determined as a reference user.

### Second Modified Example

An activity area of a target user in a target period may be decided by using a function of the estimation unit 12 described in the fifth example embodiment.

Specifically, the friend information acquisition unit 121 acquires a profile from public information of a user having a connection with a target user on social media. Then, the friend distribution generation unit 122 generates a residential place distribution indicating a distribution of places of residence of the target user, based on the profile of the user having a connection with the target user on social media acquired by the friend information acquisition unit 121.

The post information acquisition unit 123 acquires post information indicating a post location and a post date and time, from public information of a reference user. The post distribution generation unit 124 generates a post location distribution indicating a distribution of post locations of the reference user in a target period, based on the information acquired by the post information acquisition unit 123. Then, the post distribution generation unit 124 outputs the generated post location distribution indicating a distribution of post locations of the “reference user” in the target period, as a post location distribution indicating a distribution of post locations of the “target user” in the target period.

The activity area distribution generation unit 125 estimates an activity area of the target user in the target period, based on the residential place distribution indicating a distribution of places of residence of the target user output by the friend information acquisition unit 121, and the post location distribution indicating a distribution of post locations of the target user output by the post distribution generation unit 124.

While the example embodiments of the present invention have been described above with reference to the drawings, the example embodiments are exemplifications of the present invention, and various configurations other than the above can be employed. The configurations of the above-described example embodiments may be combined with each other, or a part of the configurations may be replaced with another configuration. Further, various modifications may be applied to the configurations of the above-described example embodiments, as long as such modifications do not depart from the gist. Further, the configurations and processing disclosed in the above-described example embodiments and the modified examples may be combined with each other.

Further, while a plurality of processes (pieces of processing) are described in order in a plurality of flowcharts used in the above description, execution order of processes executed in each example embodiment is not limited to the described order. The order of the illustrated processes can be changed in each example embodiment, as long as the change does not detract from contents. Further, the above example embodiments can be combined, as long as contents do not contradict each other.

The above example embodiments may also be described in part or in whole as the following supplementary notes, but are not limited thereto.

1. A processing apparatus including:
a determination unit that determines one or a plurality of reference users having a predetermined relationship with a target user whose activity area in a target period is to be estimated, based on post information posted on social media by each user within a search period being set based on the target period;
an estimation unit that estimates an activity area of the reference user in the target period; and
a decision unit that decides an activity area of the target user in the target period, based on an activity area of the reference user in the target period.
   2. The processing apparatus according to supplementary note 1, wherein
the determination unit
   determines a user having a connection with the target user on social media, and
   determines the reference user from among determined users, based on the post information of a determined user within the search period.
      3. The processing apparatus according to supplementary note 1 or 2, wherein
the predetermined relationship includes at least one of
   having posted an image including the target user within the search period,
   having posted a message mentioning the target user within the search period,
   having posted the post information in which the target user is tagged within the search period, and
   having been in a same place at same timing as the target user within the search period.
      4. The processing apparatus according to any one of supplementary notes 1 to 3, wherein
the decision unit
   sets a weight for each of a plurality of the reference users, based on the post information of each of a plurality of the reference users within the search period, and
   decides an activity area of the target user in the target period, based on an activity area of each of a plurality of the reference users in the target period and a weight of each of a plurality of the reference users.
      5. The processing apparatus according to supplementary note 4, wherein
the decision unit sets the weight, based on at least one of
   a number of images including the target user posted within the search period,
   a number of messages mentioning the target user posted within the search period, and
   a number of pieces of the post information in which the target user is tagged posted within the search period.
      6. The processing apparatus according to supplementary note 4, wherein
the decision unit sets the weight, based on at least one of
   a number of days having posted an image including the target user within the search period,
   a number of days having posted a message mentioning the target user within the search period, and
   a number of days having posted the post information in which the target user is tagged within the search period.
      7. The processing apparatus according to any one of supplementary notes 1 to 6, wherein
a number of pieces of the post information posted on social media by the target user within the target period is less than a reference value.
   8. The processing apparatus according to any one of supplementary notes 1 to 7, wherein
the decision unit
   has a first mode that decides an activity area of the target user in the target period, based on the post information posted by the target user, and a second mode that decides an activity area of the target user in the target period, based on an activity area of the reference user in the target period,
   executes the first mode when a number of pieces of the post information posted on social media by the target user within the target period is equal to or more than a reference value, and
   executes the second mode when a number of pieces of the post information posted on social media by the target user within the target period is less than the reference value.
      9. A processing method including,
by one or more computers;
determining one or a plurality of reference users having a predetermined relationship with a target user whose activity area in a target period is to be estimated, based on post information posted on social media by each user within a search period being set based on the target period;
estimating an activity area of the reference user in the target period; and
deciding an activity area of the target user in the target period, based on an activity area of the reference user in the target period.
   10. A program causing a computer to function as:
a determination unit that determines one or a plurality of reference users having a predetermined relationship with a target user whose activity area in a target period is to be estimated, based on post information posted on social media by each user within a search period being set based on the target period;
an estimation unit that estimates an activity area of the reference user in the target period; and
a decision unit that decides an activity area of the target user in the target period, based on an activity area of the reference user in the target period.

10 Processing apparatus

11 Determination unit

12 Estimation unit

13 Decision unit

121 Friend information acquisition unit

122 Friend distribution generation unit

123 Post information acquisition unit

124 Post distribution generation unit

125 Activity area distribution generation unit

1A Processor

2A Memory

3A Input/output I/F

4A Peripheral circuit

5A Bus

1. A processing apparatus comprising:
at least one memory configured to store one or more instructions; and
at least one processor configured to execute the one or more instructions to:
determine one or a plurality of reference users having a predetermined relationship with a target user whose activity area in a target period is to be estimated, based on post information posted on social media by each user within a search period being set based on the target period;
estimate an activity area of the reference user in the target period; and
decide an activity area of the target user in the target period, based on an activity area of the reference user in the target period.

2. The processing apparatus according to claim 1, wherein
the processor is further configured to execute the one or more instructions to
determine a user having a connection with the target user on social media, and
determine the reference user from among determined users, based on the post information of a determined user within the search period.

3. The processing apparatus according to claim 1, wherein
the predetermined relationship includes at least one of
having posted an image including the target user within the search period,
having posted a message mentioning the target user within the search period,
having posted the post information in which the target user is tagged within the search period, and
having been in a same place at same timing as the target user within the search period.

4. The processing apparatus according to claim 1, wherein
the processor is further configured to execute the one or more instructions to
set a weight for each of a plurality of the reference users, based on the post information of each of a plurality of the reference users within the search period, and
decide an activity area of the target user in the target period, based on an activity area of each of a plurality of the reference users in the target period and a weight of each of a plurality of the reference users.

5. The processing apparatus according to claim 4, wherein
the processor is further configured to execute the one or more instructions to set the weight, based on at least one of
a number of images including the target user posted within the search period,
a number of messages mentioning the target user posted within the search period, and
a number of pieces of the post information in which the target user is tagged posted within the search period.

6. The processing apparatus according to claim 4, wherein
the processor is further configured to execute the one or more instructions to set the weight, based on at least one of
a number of days having posted an image including the target user within the search period,
a number of days having posted a message mentioning the target user within the search period, and
a number of days having posted the post information in which the target user is tagged within the search period.

7. The processing apparatus according to claim 1, wherein
a number of pieces of the post information posted on social media by the target user within the target period is less than a reference value.

8. The processing apparatus according to claim 1, wherein
the processor is further configured to execute the one or more instructions to
have a first mode that decides an activity area of the target user in the target period, based on the post information posted by the target user, and a second mode that decides an activity area of the target user in the target period, based on an activity area of the reference user in the target period,
execute the first mode when a number of pieces of the post information posted on social media by the target user within the target period is equal to or more than a reference value, and
execute the second mode when a number of pieces of the post information posted on social media by the target user within the target period is less than the reference value.

9. A processing method comprising,
by one or more computers;
determining one or a plurality of reference users having a predetermined relationship with a target user whose activity area in a target period is to be estimated, based on post information posted on social media by each user within a search period being set based on the target period;
estimating an activity area of the reference user in the target period; and
deciding an activity area of the target user in the target period, based on an activity area of the reference user in the target period.

10. The processing method according to claim 9, wherein
the one or more computers
determine a user having a connection with the target user on social media, and
determine the reference user from among determined users, based on the post information of a determined user within the search period.

11. The processing method according to claim 9, wherein
the predetermined relationship includes at least one of
having posted an image including the target user within the search period,
having posted a message mentioning the target user within the search period,
having posted the post information in which the target user is tagged within the search period, and
having been in a same place at same timing as the target user within the search period.

12. The processing method according to claim 9, wherein
the one or more computers
set a weight for each of a plurality of the reference users, based on the post information of each of a plurality of the reference users within the search period, and
decide an activity area of the target user in the target period, based on an activity area of each of a plurality of the reference users in the target period and a weight of each of a plurality of the reference users.

13. The processing method according to claim 12, wherein
the one or more computers set the weight, based on at least one of
a number of images including the target user posted within the search period,
a number of messages mentioning the target user posted within the search period, and
a number of pieces of the post information in which the target user is tagged posted within the search period.

14. The processing method according to claim 12, wherein
the one or more computers set the weight, based on at least one of
a number of days having posted an image including the target user within the search period,
a number of days having posted a message mentioning the target user within the search period, and
a number of days having posted the post information in which the target user is tagged within the search period.

15. A non-transitory storage medium storing a program causing a computer to:
determine one or a plurality of reference users having a predetermined relationship with a target user whose activity area in a target period is to be estimated, based on post information posted on social media by each user within a search period being set based on the target period;
estimate an activity area of the reference user in the target period; and
decide an activity area of the target user in the target period, based on an activity area of the reference user in the target period.

16. The non-transitory storage medium according to claim 15, wherein
the program causing the computer to
determine a user having a connection with the target user on social media, and
determine the reference user from among determined users, based on the post information of a determined user within the search period.

17. The non-transitory storage medium according to claim 15, wherein
the predetermined relationship includes at least one of
having posted an image including the target user within the search period,
having posted a message mentioning the target user within the search period,
having posted the post information in which the target user is tagged within the search period, and
having been in a same place at same timing as the target user within the search period.

18. The non-transitory storage medium according to claim 15, wherein
the program causing the computer to
set a weight for each of a plurality of the reference users, based on the post information of each of a plurality of the reference users within the search period, and
decide an activity area of the target user in the target period, based on an activity area of each of a plurality of the reference users in the target period and a weight of each of a plurality of the reference users.

19. The non-transitory storage medium according to claim 18, wherein
the program causing the computer to set the weight, based on at least one of
a number of images including the target user posted within the search period,
a number of messages mentioning the target user posted within the search period, and
a number of pieces of the post information in which the target user is tagged posted within the search period.

20. The non-transitory storage medium according to claim 18, wherein
the program causing the computer to set the weight, based on at least one of
a number of days having posted an image including the target user within the search period,
a number of days having posted a message mentioning the target user within the search period, and
a number of days having posted the post information in which the target user is tagged within the search period.
